(19) United States
(12) Patent Application Publication
(10) Pub. No.: US 2024/0304361 A1
(43) Pub. Date: Sep. 12, 2024

(54) THERMISTOR ELEMENT AND ELECTROMAGNETIC WAVE SENSOR

(71) Applicant: TDK CORPORATION, Tokyo (JP)

(72) Inventors: Maiko KOKUBO, Tokyo (JP); Shinji Hara, Tokyo (JP); Naoki Ohta, Tokyo (JP); Susumu Aoki, Tokyo (JP)

(73) Assignee: TDK CORPORATION, Tokyo (JP)

(21) Appl. No.: 18/595,669

(22) Filed: Mar. 5, 2024

(30) Foreign Application Priority Data
Mar. 10, 2023 (JP) 2023-037506

(51) Int. Cl. H01C 7/00; G01J 5/20

(52) U.S. Cl. CPC H01C 7/008; G01J 5/20; G01J 2005/202

(57) ABSTRACT

A thermistor element includes: a thermistor film formed of an oxide having a spinel crystal structure; a first surface-side electrode provided in contact with a first surface of the thermistor film; and a second surface-side electrode provided in contact with a second surface of the thermistor film, wherein the first surface-side electrode includes a first electrode and a second electrode, and at least a part of the first electrode and at least a part of the second electrode are disposed to overlap the second surface-side electrode, and in the thermistor film, an oxygen concentration of a second region between the first electrode and the second electrode in a plan view is higher than that of a first region consisting of a region that overlaps the first electrode and the second surface-side electrode and a region that overlaps the second electrode and the second surface-side electrode.

### CROSS-REFERENCES TO RELATED APPLICATIONS

This application relies for priority upon Japanese Patent Application No. 2023-037506 filed on Mar. 10, 2023, the entire contents of which are hereby incorporated herein by reference for all purposes as if fully set forth herein.

### BACKGROUND

The present disclosure relates to a thermistor element and an electromagnetic wave sensor.

In the related art, there is an electromagnetic wave sensor including electromagnetic wave detection elements such as thermistor elements. In a thermistor element provided in such an electromagnetic wave sensor, since infrared rays incident on the thermistor element are absorbed by a thermistor film or a material near the thermistor film, the temperature of the thermistor film may change and thus electrical resistance of the thermistor film may change.

An example of such an electromagnetic wave sensor using thermistor elements is described in Patent Document 1. An electromagnetic wave sensor including thermistor elements which are arranged in an array is described in Patent Document 1. In Patent Document 1, a thermistor element including a thermistor film, a pair of first electrodes provided in contact with one surface of the thermistor film, and a second electrode provided in contact with the other surface of the thermistor film is described.

The thermistor element described in Patent Document 1 has a current-perpendicular-to-plane (CPP) structure in which a current flows in a direction perpendicular to the surface of the thermistor film.

### PATENT DOCUMENTS

[Patent Document 1] Japanese Unexamined Patent Application, First Publication No. 2022-126582

### SUMMARY

However, in the electromagnetic wave sensor according to the related art using thermistor elements having a CPP structure in which a current flows in the direction perpendicular to the surface of the thermistor film, there is need for further improvement in measurement accuracy.

It is desirable to provide a thermistor element that can provide an electromagnetic wave sensor with high measurement accuracy and an electromagnetic wave sensor including the thermistor element.

The following means are provided.

According to an aspect of the present disclosure, there is provided a thermistor element including: a thermistor film formed of an oxide having a spinel crystal structure; a first surface-side electrode provided in contact with a first surface of the thermistor film; and a second surface-side electrode provided in contact with a second surface of the thermistor film, wherein the first surface-side electrode includes a first electrode and a second electrode that is disposed to be separated from the first electrode in a plan view, and at least a part of the first electrode and at least a part of the second electrode are disposed to overlap the second surface-side electrode in a plan view, and an oxygen concentration of a second region located between the first electrode and the second electrode in the thermistor film is higher than an oxygen concentration of a first region consisting of a region that overlaps the first electrode and the second surface-side electrode in a plan view and a region that overlaps the second electrode and the second surface-side electrode in a plan view.

### BRIEF DESCRIPTION OF THE DRAWINGS

FIG. 1 is a plan view illustrating a configuration of an electromagnetic wave sensor according to an embodiment of the present disclosure.

FIG. 2 is an exploded perspective view illustrating the configuration of the electromagnetic wave sensor illustrated in FIG. 1.

FIG. 3 is a partially enlarged plan view of the electromagnetic wave sensor illustrated in FIG. 1 and a plan view of a layer in which a first surface-side electrode of a thermistor element is provided.

FIG. 4 is a partially enlarged sectional view of the electromagnetic wave sensor illustrated in FIG. 1 and a sectional view along line A-A in FIG. 3.

FIG. 5 is a sectional view sequentially illustrating a process of manufacturing a thermistor element provided in the electromagnetic wave sensor illustrated in FIG. 1.

FIG. 6 is a sectional view sequentially illustrating a process of manufacturing the thermistor element provided in the electromagnetic wave sensor illustrated in FIG. 1.

FIG. 7 is a sectional view sequentially illustrating a process of manufacturing the thermistor element provided in the electromagnetic wave sensor illustrated in FIG. 1.

FIG. 8 is a sectional view sequentially illustrating a process of manufacturing the thermistor element provided in the electromagnetic wave sensor illustrated in FIG. 1.

FIG. 9 is a sectional view sequentially illustrating a process of manufacturing the thermistor element provided in the electromagnetic wave sensor illustrated in FIG. 1.

FIG. 10 is a sectional view sequentially illustrating a process of manufacturing the thermistor element provided in the electromagnetic wave sensor illustrated in FIG. 1.

FIG. 11 is a sectional view sequentially illustrating a process of manufacturing the thermistor element provided in the electromagnetic wave sensor illustrated in FIG. 1.

FIG. 12 is a sectional view sequentially illustrating a process of manufacturing the thermistor element provided in the electromagnetic wave sensor illustrated in FIG. 1.

FIG. 13 is a graph illustrating a relationship between a position in a thickness direction of a cross-section including a first region 5a of a thermistor element 4 according to Example 1 and element concentrations.

FIG. 14 is a graph illustrating a relationship between a position in the thickness direction of a cross-section including a second region 5b of the thermistor element 4 according to Example 1 and element concentrations.

### DETAILED DESCRIPTION

In order to achieve the aforementioned objective, the inventor earnestly studied a thermistor element including a first electrode and a second electrode provided in contact with a first surface of a thermistor film and provided to be apart from each other and a second surface-side electrode provided in contact with a second surface of the thermistor film such that measurement accuracy of an electromagnetic wave sensor including the thermistor element is improved.

As a result, the inventor found that a current component flowing in an in-plane direction of the thermistor film between the first electrode and the second electrode via the thermistor film is one factor that decreases measurement accuracy of the electromagnetic wave sensor including the thermistor element.

Therefore, the inventor studied with a focus on electrical resistance and materials of the thermistor film. As a result, the inventor found that a thermistor film of a thermistor element should be formed of an oxide having a spinel crystal structure and an oxygen concentration in a second region located between the first electrode and the second electrode in a plan view should be higher than in a first region consisting of a region that overlaps the first electrode and the second surface-side electrode in a plan view and a region that overlaps the second electrode and the second surface-side electrode in a plan view, and made the present disclosure.

In such a thermistor element, it is estimated that electric resistivity of the thermistor film is higher in the second region than in the first region and a current does not easily flow in an in-plane direction of the thermistor film between the first electrode and the second electrode. As a result, with an electromagnetic wave sensor including such thermistor elements, it is estimated that a decrease in measurement accuracy due to a current component flowing in the in-plane direction of the thermistor film between the first electrode and the second electrode is curbed and measurement accuracy is high.

The present disclosure includes the following configurations.

[1] A thermistor element including:
a thermistor film formed of an oxide having a spinel crystal structure;
a first surface-side electrode provided in contact with a first surface of the thermistor film; and
a second surface-side electrode provided in contact with a second surface of the thermistor film,
wherein the first surface-side electrode includes a first electrode and a second electrode that is disposed to be separated from the first electrode in a plan view, and at least a part of the first electrode and at least a part of the second electrode are disposed to overlap the second surface-side electrode in a plan view, and
wherein an oxygen concentration of a second region located between the first electrode and the second electrode in a plan view in the thermistor film is higher than an oxygen concentration of a first region consisting of a region that overlaps the first electrode and the second surface-side electrode in a plan view and a region that overlaps the second electrode and the second surface-side electrode in a plan view.

[2] An electromagnetic wave sensor including the thermistor element according to [1].

The thermistor element according to the present disclosure is formed of an oxide having a spinel crystal structure and includes a thermistor film in which the oxygen concentration in the second region located between the first electrode and the second electrode in a plan view is higher than the oxygen concentration of the first region consisting of a region that overlaps the first electrode and the second surface-side electrode in a plan view and a region that overlaps the second electrode and the second surface-side electrode in a plan view. Accordingly, in the thermistor element according to the present disclosure, a current does not easily flow in an in-plane direction in the second region of the thermistor film. As a result, in the electromagnetic wave sensor including the thermistor element according to the present disclosure, a decrease in measurement accuracy due to a current component flowing in the in-plane direction in the thermistor film of the thermistor element is curbed, and measurement accuracy is enhanced.

Hereinafter a thermistor element and an electromagnetic wave sensor according to an embodiment will be described in detail with reference to the accompanying drawings. In the drawings mentioned in the following description, for the purpose of convenience, feature parts may be enlarged so that features of the present disclosure can be easily understood. Accordingly, dimensions, ratios, and the like of constituents may be different from real ones. Materials, dimensions, and the like described in the following description are merely examples, and the present disclosure is not limited thereto but can be appropriately modified without departing from the gist thereof.

### [Electromagnetic Wave Sensor]

An electromagnetic wave sensor according to this embodiment detects electromagnetic waves which are radiated from a measurement target. Examples of electromagnetic waves detected by the electromagnetic wave sensor according to this embodiment include infrared rays and terahertz waves. Specifically, the electromagnetic wave sensor according to this embodiment may detect, for example, infrared rays of which a wavelength is equal to or greater than 0.75 μm and equal to or less than 1000 μm (hereinafter also referred to as “infrared rays IR”). The infrared rays IR may be far-infrared rays, mid-infrared rays, or near-infrared rays. The infrared rays IR may be long-wavelength infrared rays of which a wavelength ranges from 8 μm to 14 μm. The electromagnetic wave sensor according to this embodiment may detect, for example, terahertz waves of which a wavelength is equal to or greater than 30 μm and equal to or less than 3 mm.

Hereinafter, an electromagnetic wave sensor detecting infrared rays IR radiated from a measurement target will be described as an example of the electromagnetic wave sensor according to this embodiment. The electromagnetic wave sensor according to this embodiment may be an infrared imaging device (an infrared image sensor) that detects infrared rays IR radiated from a measurement target and two-dimensionally detects (images) a temperature distribution of the measurement target. The infrared image sensor may be used for an infrared camera for indoor and/or outdoor dark vision or the like. The infrared image sensor may be used as a non-contact type temperature sensor for measuring the temperature of a person or an object, or the like.

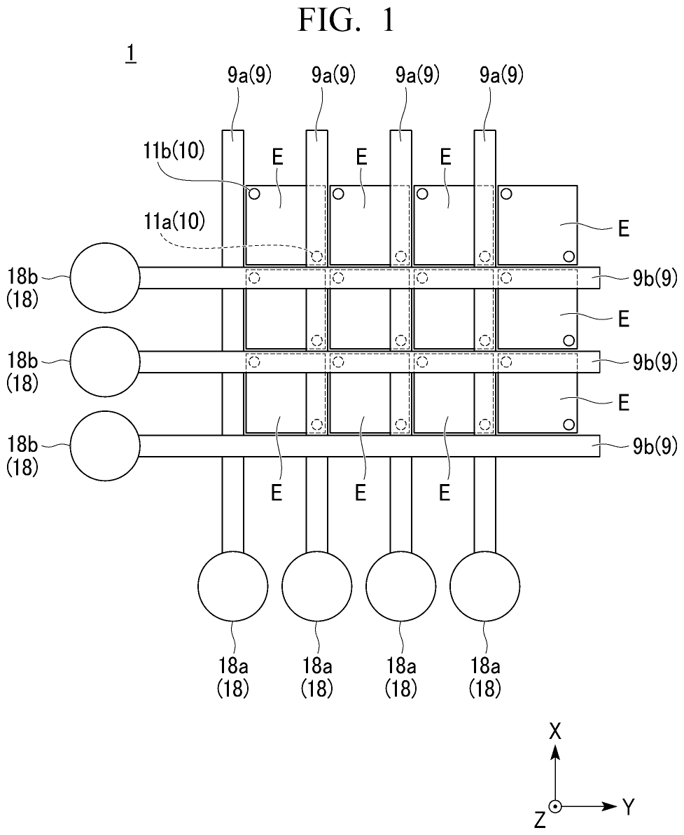

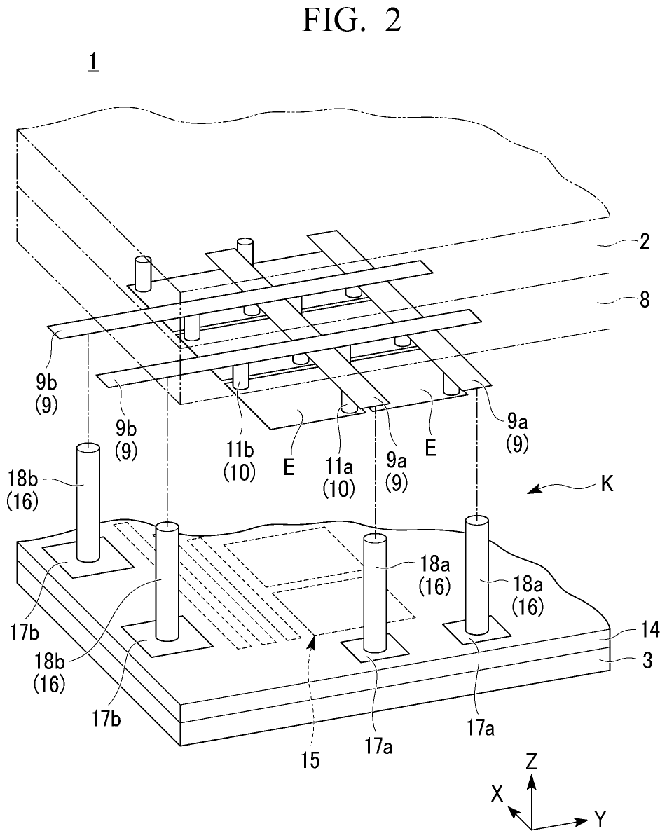

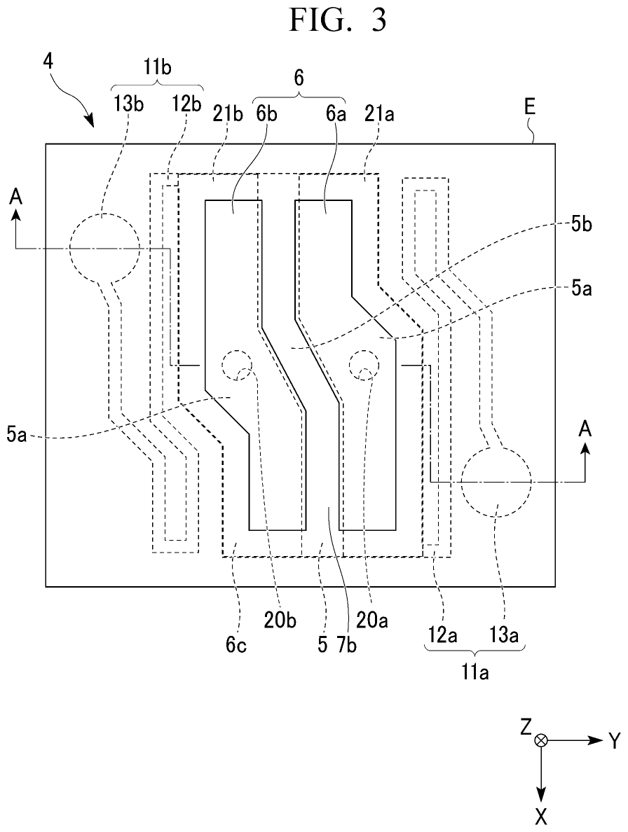

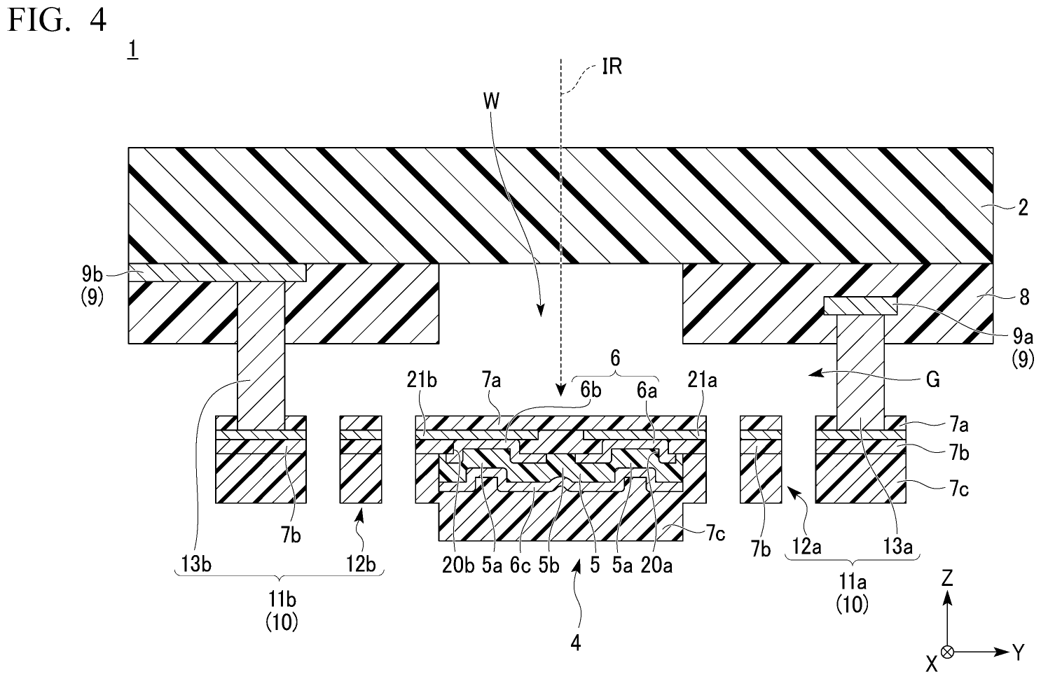

FIG. 1 is a plan view illustrating a configuration of an electromagnetic wave sensor according to an embodiment of the present disclosure. FIG. 2 is an exploded perspective view illustrating the configuration of the electromagnetic wave sensor illustrated in FIG. 1. FIG. 3 is a partially enlarged plan view of the electromagnetic wave sensor illustrated in FIG. 1 and a plan view of a layer in which a first surface-side electrode of a thermistor element is provided. FIG. 4 is a partially enlarged sectional view of the electromagnetic wave sensor illustrated in FIG. 1 and a sectional view along line A-A in FIG. 3. FIGS. 5 to 12 are sectional views sequentially illustrating processes of manufacturing a thermistor element provided in the electromagnetic wave sensor illustrated in FIG. 1.

In FIGS. 1 to 12, an XYZ orthogonal coordinate system is set. In FIGS. 1 to 12, an X-axis direction is defined as a first direction X in a specific plane of the electromagnetic wave sensor, a Y-axis direction is defined as a second direction Y perpendicular to the first direction X in the specific plane of the electromagnetic wave sensor, and a Z-axis direction is defined as a third direction Z perpendicular to the specific plane of the electromagnetic wave sensor.

As illustrated in FIG. 2, the electromagnetic wave sensor 1 according to this embodiment includes a first substrate 2 and a second substrate 3 that are disposed to face each other and the thermistor elements 4 that are disposed between the first substrate 2 and the second substrate 3. A single thermistor element 4 is provided for each region E. The regions E are regions which are defined by the first lead wires 9a and the second lead wires 9b in a plan view as illustrated in FIGS. 1 and 2.

As illustrated in FIG. 2, the first substrate 2 and the second substrate 3 form a closed internal space K therebetween by sealing the surroundings of the opposite surfaces with a sealing material (not illustrated). The internal space K is decompressed in a high vacuum. Accordingly, in the electromagnetic wave sensor 1 according to this embodiment, an influence of heat due to convection in the internal space K is curbed, and an influence of heat other than infrared rays IR radiated from a measurement target to the thermistor element 4 is excluded.

The electromagnetic wave sensor 1 according to this embodiment is not limited to the configuration including the closed and decompressed internal space K. The electromagnetic wave sensor 1 according to this embodiment may have a configuration including a closed internal space K with atmospheric pressure or may have a configuration including an open internal space K.

The first substrate 2 and the second substrate 3 are formed of substrates which are transparent to electromagnetic waves of a specific wavelength. For example, when the electromagnetic waves of a specific wavelength are infrared rays IR, for example, silicon substrates can be used as the first substrate 2 and the second substrate 3, or germanium substrates or the like may be used.

The thermistor elements 4 provided in the electromagnetic wave sensor 1 have the same size. As illustrated in FIGS. 1 and 2, the thermistor elements 4 are arranged in an array in a plane parallel to the first substrate 2 and the second substrate 3 (hereinafter referred to as a “specific plane”).

The thermistor elements 4 are provided for the regions E illustrated in FIGS. 1 and 2, and thus the thermistor elements 4 are arranged in a matrix shape in the first direction X and the second direction Y crossing each other (perpendicular to each other in this embodiment) in the specific plane. The thermistor elements 4 are arranged at constant intervals in the first direction X and are arranged at constant intervals in the second direction Y, where the first direction X is a row direction and the second direction Y is a column direction.

The numbers of rows and columns of the thermistor elements 4 (that is, the numbers of rows and columns of the regions E) may be, for example, 640 rows×480 columns or 1024 rows×768 columns. The numbers of rows and columns of the thermistor elements 4 are not limited thereto and can be appropriately changed.

### [Thermistor Element]

As illustrated in FIG. 4, each thermistor element 4 includes a thermistor film 5 serving as a temperature detecting element, a first surface-side electrode 6 provided in contact with one surface (a first surface) of the thermistor film 5, and a second surface-side electrode 6c provided in contact with the other surface (a second surface) of the thermistor film 5.

The first surface-side electrode 6 is a pair of electrodes including a first electrode 6a and a second electrode 6b. As illustrated in FIGS. 3 and 4, the first electrode 6a and the second electrode 6b are separated from each other in a plan view. As illustrated in FIGS. 3 and 4, at least a part (the whole part in this embodiment) of the first electrode 6a and at least part (the whole part in this embodiment) of the second electrode 6b are disposed to overlap the second surface-side electrode 6c and the thermistor film 5 in a plan view. The first electrode 6a and the second electrode 6b in this embodiment have the substantially same shape.

The second surface-side electrode 6c in this embodiment can be formed, for example, in the same shape as the thermistor film 5 in a plan view as illustrated in FIGS. 3 and 4.

As illustrated in FIG. 4, each thermistor element 4 provided in the electromagnetic wave sensor 1 according to this embodiment has a current-perpendicular-to-plane (CPP) structure in which the first surface-side electrode 6 (the first electrode 6a and the second electrode 6b) and the second surface-side electrode 6c are provided with the thermistor film 5 interposed therebetween and a current flows in a direction perpendicular to the surface of the thermistor film 5. The thermistor element 4 can cause a current to flow in the direction perpendicular to the surface of the thermistor film 5 from the first electrode 6a of the first surface-side electrode 6 to the second surface-side electrode 6c and cause a current to flow in the direction perpendicular to the surface of the thermistor film 5 from the second surface-side electrode 6c to the second electrode 6b.

As illustrated in FIG. 4, wiring layers 21a and 21b are in contact with the sides of the first electrode 6a and the second electrode 6b of the first surface-side electrode 6 opposite to the thermistor film 5. In this embodiment, parts of the first electrode 6a and the second electrode 6b not in contact with the thermistor film 5 and the wiring layers 21a and 21b are covered by a second insulating film 7b (an insulating film). The second insulating film 7b is also provided between the first electrode 6a and the second electrode 6b of the first surface-side electrode 6 in a plan view as illustrated in FIGS. 3 and 4. Accordingly, the second insulating film 7b is in contact with a part of one surface (the first surface) of the thermistor film 5 not in contact with the first surface-side electrode 6 (the first electrode 6a and the second electrode 6b).

In the second insulating film 7b according to this embodiment, as illustrated in FIGS. 3 and 4, circular openings 20a and 20b penetrating the second insulating film 7b are provided at positions overlapping a substantially central part of the first electrode 6a and a substantially central part of the second electrode 6b in a plan view. As illustrated in FIGS. 3 and 4, the first electrode 6a and the second electrode 6b are continuously formed in parts located in regions overlapping the openings 20a and 20b in a plan view and parts located in a region other than the regions overlapping the openings 20a and 20b in a plan view. Accordingly, each of the first electrode 6a and the second electrode 6b has a shape including a protruded/recessed portion in which the thermistor film 5 side is recessed and the wiring layers 21a and 21b side is protruded. As a result, in comparison with a case in which the protruded/recessed portion is not provided, a contact area of the first electrode 6a and the second electrode 6b with the thermistor film 5 is larger.

In this embodiment, as illustrated in FIGS. 3 and 4, the whole surfaces of the first electrode 6a and the second electrode 6b on the thermistor film 5 side are in contact with one surface of the thermistor film 5, and the whole surface of the second surface-side electrode 6c on the thermistor film 5 side is in contact with the other surface of the thermistor film 5. Accordingly, the thermistor film 5 and the second surface-side electrode 6c include two protruded/recessed portions corresponding to the shape inside of the protruded/recessed portions of the first electrode 6a and the second electrode 6b as illustrated in FIG. 4.

As illustrated in FIG. 4, an insulating film 7a is disposed on the side of the wiring layers 21a and 21b and the second insulating film 7b opposite to the thermistor film 5 to cover the wiring layers 21a and 21b and the second insulating film 7b.

On the side of the second surface-side electrode 6c opposite to the thermistor film 5, a third insulating film 7c is provided in contact with the second surface-side electrode 6c. In this embodiment, as illustrated in FIG. 4, the third insulating film 7c covers the side surfaces of the second surface-side electrode 6c and the thermistor film 5 and is in contact with the surface of the second insulating film 7b on the thermistor film 5 side.

The thermistor film 5 is formed of an oxide having a spinel crystal structure, and an oxygen concentration of a second region 5b located between the first electrode 6a and the second electrode 6b in a plan view is higher than the oxygen concentration of a first region 5a consisting of a region that overlaps the first electrode 6a and the second surface-side electrode 6c in a plan view and a region that overlaps the second electrode 6b and the second surface-side electrode 6c in a plan view.

The oxygen concentration of the second region 5b is higher than one time the oxygen concentration of the first region 5a, may be equal to or higher than 1.2 times, and may be equal to or higher than 1.5 times. As an oxygen concentration ratio between the second region 5b and the first region 5a of the thermistor film 5 increases, a difference in electric resistivity between the first region 5a and the second region 5b increases, a current flows more easily in the direction perpendicular to the surface in the first region 5a, and a current flows less easily in the in-plane direction in the second region 5b. As a result, a decrease in measurement accuracy due to a current component flowing in the in-plane direction in the thermistor film 5 is curbed, and the measurement accuracy is enhanced.

Since the thermistor element can be efficiently manufactured using a manufacturing method which will be described later, the oxygen concentration of the second region 5b may be equal to or lower than two times the oxygen concentration of the first region 5a and may be equal to or lower than 1.8 times.

The oxygen concentration of the first region 5a may be substantially uniform in the thickness direction. In this embodiment, when the thermistor film 5 is divided into three regions including a region close to one surface (the first surface), a region close to the other surface (the second surface), and a region including a central part in the thickness direction in the thickness direction, the oxygen concentration of the second region 5b is higher than the oxygen concentration of the first region 5a in any of the three regions. Accordingly, a current flows more easily in the direction perpendicular to the surface in the first region 5a and a current flows less easily in the in-plane direction in the second region 5b.

The thermistor film 5 is formed of an oxide having a spinel crystal structure. When heat treatment at 250° C. or higher in the atmospheric air is performed on a film formed of an oxide having a spinel crystal structure after an insulating film formed of an oxide has been disposed in contact therewith, oxygen can diffuse from the insulating film to increase the oxygen concentration in the oxide having a spinel crystal structure.

In the oxide having a spinel crystal structure, for example, a base metal element including cobalt (Co) and manganese (Mn) or a base metal element including nickel (Ni) and manganese (Mn) may be located in at least a part of one or both of site A and site B of the spinel crystal structure. Such a base metal element can be located in any of site A and site B of the spinel crystal structure expressed by Formula AB₂O₄.

The oxide having a spinel crystal structure may include, for example, at least one additive element selected from transition metal elements such as cobalt (Co), nickel (Ni), copper (Cu), iron (Fe), zirconium (Zr)m, titanium (Ti), vanadium (V), chromium (Cr), scandium (Sc), Yttrium (Y), niobium (Nb), and molybdenum (Mo), aluminum (Al), and zinc (Zn) in addition to the base metal element. The additive element may include at least one selected from aluminum (Al), cobalt (Co), nickel (Ni), copper (Cu), iron (Fe), and zirconium (Zr). The additive element can be positioned in any of site A and site B of the spinel crystal structure expressed by formula AB₂O₄. The additive element may be substitutionally dissolved in one or both of site A and site B of the spinel crystal structure or may be positioned in a site other than site A and site B without being substitutionally dissolved in site A and site B.

In this embodiment, the thickness of the thermistor film 5 may range from 80 nm to 300 nm and may range from 100 nm to 200 nm.

The first electrode 6a and the second electrode 6b of the first surface-side electrode 6 and the second surface-side electrode 6c are both formed of a conductive film. When the thermistor element 4 is manufactured using a manufacturing method which will be described later, the first electrode 6a and the second electrode 6b also serve as an oxygen diffusion suppressing layer for suppressing diffusion of oxygen from the second insulating film 7b to the thermistor film 5. When the thermistor element 4 is manufactured using a manufacturing method which will be described later, the second surface-side electrode 6c also serves as an oxygen diffusion suppressing layer for suppressing diffusion of oxygen from the heat treatment atmosphere (for example, the atmospheric air) to the thermistor film 5. The conductive films forming the first electrode 6a, the second electrode 6b, and the second surface-side electrode 6c may be different or some or all thereof may be the same.

In this embodiment, as the conductive films forming the first electrode 6a and the second electrode 6b of the first surface-side electrode 6 and the second surface-side electrode 6c, for example, films including at least one selected from platinum (Pt), gold (Au), palladium (Pd), silver (Ag), ruthenium (Ru), iridium (Ir), rhodium (Rh), osmium (Os), titanium (Ti), rhenium (Re), copper (Cu), nickel (Ni), tantalum (Ta), chromium (Cr), and nickel-chromium (NiCr) alloys can be used. Each of the first electrode 6a, the second electrode 6b, and the second surface-side electrode 6c may be a stacked film in which the conductive films are stacked. For example, a stacked film in which two conductive films including a nickel-chromium (NiCr) alloy film and a platinum (Pt) film are stacked can be used as each of the first electrode 6a and the second electrode 6b.

In this embodiment, all of the first electrode 6a, the second electrode 6b, and the second surface-side electrode 6c may be be conductive films formed of a precious metal (a simple precious metal or an alloy including precious metal elements) selected from platinum (Pt), gold (Au), palladium (Pd), silver (Ag), ruthenium (Ru), iridium (Ir), rhodium (Rh), osmium (Os), and rhenium (Re). This is because it is less easily degenerated and a degenerated layer is less easily formed between the electrodes and the thermistor film 5 at the time of heat treatment in the method of manufacturing the thermistor element 4 which will be described later. All of the first electrode 6a, the second electrode 6b, and the second surface-side electrode 6c may be conductive films formed of precious metal, since they have excellent conductivity. When each of the first electrode 6a, the second electrode 6b, and the second surface-side electrode 6c is a stacked film in which the conductive films are stacked, the conductive film in contact with the thermistor film 5 may be formed of precious metal.

In this embodiment, the thicknesses of the first electrode 6a, the second electrode 6b, and the second surface-side electrode 6c range, for example, from 7 nm to 100 nm. The thicknesses of the first electrode 6a and the second electrode 6b may be thicknesses with which they serve as oxygen diffusion suppressing layers for suppressing diffusion of oxygen from the second insulating film 7b to the thermistor film 5 at the time of heat treatment. The thicknesses of the first electrode 6a and the second electrode 6b are appropriately determined according to the material of the first electrode 6a and the second electrode 6b and the material of the second insulating film 7b. The thickness of the second surface-side electrode 6c may be a thickness with which it can serve as an oxygen diffusion suppressing layer for suppressing diffusion of oxygen from the heat treatment atmosphere (for example, the atmospheric air) to the thermistor film 5 at the time of heat treatment. The thickness of the second surface-side electrode 6c is appropriately determined according to the material of the second surface-side electrode 6c.

The materials of the first insulating film 7a, the second insulating film 7b, and the third insulating film 7c may be different or some or all thereof may be the same. As each of the first insulating film 7a, the second insulating film 7b, and the third insulating film 7c, for example, a film formed of aluminum nitride, silicon nitride, aluminum oxide, silicon oxide, magnesium oxide, tantalum oxide, niobium oxide, hafnium oxide, zirconium oxide, germanium oxide, yttrium oxide, tungsten oxide, bismuth oxide, calcium oxide, aluminum oxynitride, silicon oxynitride, aluminum magnesium oxide, silicon boride, boron nitride, or sialon (oxynitride of silicon and aluminum) can be used.

In this embodiment, for the following reasons, at least the second insulating film 7b of the first insulating film 7a, the second insulating film 7b, and the third insulating film 7c may be formed of an oxide. As illustrated in FIGS. 3 and 4, a part of the second insulating film 7b is located between the first electrode 6a and the second electrode 6b of the first surface-side electrode 6 and is in contact with a part of one surface (the first surface) of the thermistor film 5 located between the first electrode 6a and the second electrode 6b in a plan view. Accordingly, when the second insulating film 7b is formed of an oxide, oxygen can be diffused from the second insulating film 7b to the thermistor film 5 by manufacturing the thermistor element 4 using a manufacturing method which will be described later. As a result, it is possible to easily manufacture the thermistor element 4 including thermistor film 5 in which the oxygen concentration in the second region 5b is higher than that in the first region 5a.

### [Element Periphery Structure]

As illustrated in FIG. 2, a first insulator layer 8, a wiring part 9 that is electrically connected to a circuit part 15 which will be described later, and a first connection part 10 that electrically connects each thermistor element 4 and the wiring part 9 are provided on one surface of the first substrate 2 (a surface facing the second substrate 3) in the electromagnetic wave sensor 1 according to this embodiment.

The first insulator layer 8 is an insulating film stacked on one surface of the first substrate 2 (the surface facing the second substrate 3). For example, one or two or more kinds of insulating films formed of aluminum nitride, silicon nitride, aluminum oxide, silicon oxide, magnesium oxide, tantalum oxide, niobium oxide, hafnium oxide, zirconium oxide, germanium oxide, yttrium oxide, tungsten oxide, bismuth oxide, calcium oxide, aluminum oxinitride, silicon oxynitride, aluminum magnesium oxide, silicon boride, boron nitride, or sialon (oxynitride of silicon and aluminum) can be used as the first insulator layer 8.

As illustrated in FIGS. 1 and 2, the wiring part 9 includes the first lead wires 9a and the second lead wires 9b. The first lead wires 9a extend in the first direction X and are arranged at constant intervals in the second direction Y. On the other hand, the second lead wires 9b extend in the second direction Y and are arranged at constant intervals in the first direction X. As illustrated in FIG. 4, the first lead wires 9a and the second lead wires 9b are disposed at different positions in the thickness direction (the third direction Z) of the first insulator layer 8 and are provided to three-dimensionally cross each other as illustrated in FIG. 2.

Each first lead wire 9a and each second lead wire 9b are formed of, for example, a conductive film of copper or gold.

A first connection part 10 includes a pair of first connection members 11a and 11b. As illustrated in FIGS. 3 and 4, the pair of first connection members 11a and 11b include a pair of arm parts 12a and 12b and a pair of leg parts 13a and 13b. The leg parts 13a and 13b of the pair of first connection members 11a and 11b are disposed at ends in a diagonal direction of each region E having a substantially rectangular shape in a plan view (see FIGS. 1 to 4).

As illustrated in FIG. 4, each of the arm parts 12a and 12b includes a part of each of the wiring layers 21a and 21b (a conductor pattern part which will be described later), the first insulating film 7a covering one surface of the wiring layers 21a and 21b, the second insulating film 7b covering the other surface of the wiring layers 21a and 21b, and the third insulating film 7c covering the surface of the second insulating film 7b opposite to the wiring layers 21a and 21b.

As illustrated in FIGS. 3 and 4, each of the wiring layers 21a and 21b includes a conductor pattern part of a bent line shape that is formed along the perimeter of the thermistor film 5 in a plan view and a conductor part that is formed at a position overlapping the thermistor film 5 in a plan view and connected to the first electrode 6a or the second electrode 6b.

All the first insulating film 7a, the second insulating film 7b, and the third insulating film 7c covering the wiring layers 21a and 21b forming the conductor pattern part are formed in the substantially same shape as the shapes of the wiring layers 21a and 21b forming the conductor pattern part in a plan view.

The wiring layers 21a and 21b are formed of, for example, at least one kind selected from aluminum, tungsten, titanium, tantalum, titanium nitride, tantalum nitride, chromium nitride, and zirconium nitride.

The leg part 13a serves as a contact plug that electrically connects the first lead wire 9a and the wiring layer 21a of the arm part 12a. The leg part 13b serves as a contact plug that electrically connects the second lead wire 9b and the wiring layer 21b of the arm part 12b. As illustrated in FIGS. 3 and 4, each of the leg parts 13a and 13b is formed of a conductor pillar with a circular section formed to extend in the third direction Z.

Each of the leg parts 13a and 13b is formed of, for example, copper, gold, FeCoNi alloy, or NiFe alloy (permalloy).

As illustrated in FIGS. 3 and 4, the first connection member 11a includes the wiring layer 21a electrically connected to the first electrode 6a of the first surface-side electrode 6 and the leg part 13a electrically connecting the wiring layer 21a and the first lead wire 9a and electrically connects the first electrode 6a and the first lead wire 9a.

The first connection member 11b includes the wiring layer 21b electrically connected to the second electrode 6b and the leg part 13b electrically connecting the wiring layer 21b and the second lead wire 9b and electrically connects the second electrode 6b and the second lead wire 9b.

As illustrated in FIG. 2, a second insulator layer 14, a circuit part 15, a second connection part 16, and connection terminals 17a and 17b are provided on one surface of the second substrate 3 (a surface facing the first substrate 2) in the electromagnetic wave sensor 1 according to this embodiment.

The second insulator layer 14 is an insulating film stacked on one surface (the surface facing the first substrate 2) of the second substrate 3. The same as the insulating film used for the first insulator layer 8 can be used as the second insulator layer 14. The insulating film forming the second insulator layer 14 may be the same as the insulating film forming the first insulator layer 8 or may be different therefrom.

The circuit part 15 detects a change in voltage output from the thermistor element 4 and converts the detected change in voltage to a luminance temperature. The circuit part 15 is provided in the layer of the second insulator layer 14. The circuit part is formed of a readout integrated circuit (ROIC), a regulator, an analog-to-digital (A/D) converter, a multiplexer, or the like.

As illustrated in FIG. 2, the circuit part 15 is electrically connected to the first lead wires 9a via a second connection member 18a and the connection terminal 17a. The circuit part 15 is electrically connected to the second lead wires 9b via a second connection member 18b and the connection terminal 17b.

As illustrated in FIG. 2, the second connection part 16 includes a plurality of second connection members 18a and 18b. Each of the second connection members 18a and 18b is formed of a conductor pillar having a circular section formed to extend in the third direction Z. The second connection members 18a and 18b are provided to correspond to the first lead wires 9a and the second lead wires 9b. The second connection member 18a electrically connects one end of the first lead wire 9a and the connection terminal 17a. The second connection member 18b electrically connects one end of the second lead wire 9b and the connection terminal 17b.

The second connection members 18a and 18b are formed of, for example, a conductive material such as copper and/or gold.

As illustrated in FIG. 2, the connection terminals 17a and 17b are provided on the surface of the second insulator layer 14. The connection terminals 17a and 17b correspond to the first lead wires 9a and the second lead wires 9b. The connection terminal 17a is located in a region on one side in the first direction X surrounding the circuit part 15 and is arranged at constant intervals in the second direction Y. The connection terminal 17b is located in a region on one side in the second direction Y surrounding the circuit part 15 and is arranged at constant intervals in the first direction X. The connection terminals 17a and 17b are formed of, for example, a conductive material such as copper and/or gold.

As illustrated in FIGS. 1 and 2, the thermistor element 4 in the electromagnetic wave sensor 1 according to this embodiment is provided for each region defined by the first lead wires 9a and the second lead wires 9b in a plan view.

As illustrated in FIGS. 2 and 4, the thermistor elements 4 are supported by a pair of first connection members 11a and 11b in a state in which they are suspended in the third direction Z. Accordingly, as illustrated in FIG. 4, a space G is provided between the thermistor element 4 and the first insulator layer 8. As illustrated in FIG. 4, a window part W transmitting infrared rays IR between the first substrate 2 and the thermistor film 5 is present in a region facing the thermistor film 5 of each thermistor element 4 in the thickness direction of the first substrate 2 (an overlapping region in a plan view).

In the electromagnetic wave sensor 1 according to this embodiment, infrared rays IR radiated from a measurement target is input from the first substrate 2 side to the thermistor element 4 via the window part W. The infrared rays IR input to the thermistor element 4 are absorbed by the first insulating film 7a, the second insulating film 7b, and the third insulating film 7c which are formed in the vicinity of the thermistor film 5 and the thermistor film 5. Accordingly, the temperature of the thermistor film 5 changes, electrical resistance thereof changes, and an output voltage between the first electrode 6a and the second electrode 6b of the first surface-side electrode 6 changes. Accordingly, in the electromagnetic wave sensor 1 according to this embodiment, the thermistor element 4 serves as a bolometer element.

The electromagnetic wave sensor 1 according to this embodiment two-dimensionally detects infrared rays IR radiated from a measurement target using the thermistor elements 4. In the electromagnetic wave sensor 1 according to this embodiment, it is possible to two-dimensionally detect (image) a temperature distribution (a temperature image) of a measurement target by converting electrical signals (voltage signals) output from the thermistor elements 4 to luminance temperatures. When a positive voltage is applied to the thermistor film 5 of each thermistor element 4, a change in current flowing in the thermistor film 5 with a change in temperature of the thermistor film 5 can be detected and converted to a luminance temperature.

### [Method of Manufacturing Electromagnetic Wave Sensor]

A method of manufacturing the electromagnetic wave sensor 1 according to this embodiment will be described below. The electromagnetic wave sensor 1 according to this embodiment can be manufactured, for example, using the following manufacturing method.

First, the aforementioned members such as the first insulator layer 8, the wiring part 9, and the leg parts 13a and 13b are formed on the first substrate 2 using known methods. Thereafter, a thermistor element 4 is formed on the surface of the first substrate 2 on the first insulator layer 8 side using the following method.

FIGS. 5 to 12 are sectional views sequentially illustrating processes of manufacturing a thermistor element provided in the electromagnetic wave sensor illustrated in FIG. 1. In this embodiment, for example, the constituent members of the thermistor element 4 are sequentially formed from a member disposed on the first insulating film 7a side to the third insulating film 7c.

First, a known organic material layer 30 formed of a resistor or the like is formed on the surface of the first substrate 2 in which the aforementioned members are formed on the first insulator layer 8 side. Then, as illustrated in FIG. 5, for example, the first insulating film 7a formed of aluminum oxide (Al₂O₃) is formed on the whole surface of the organic material layer 30.

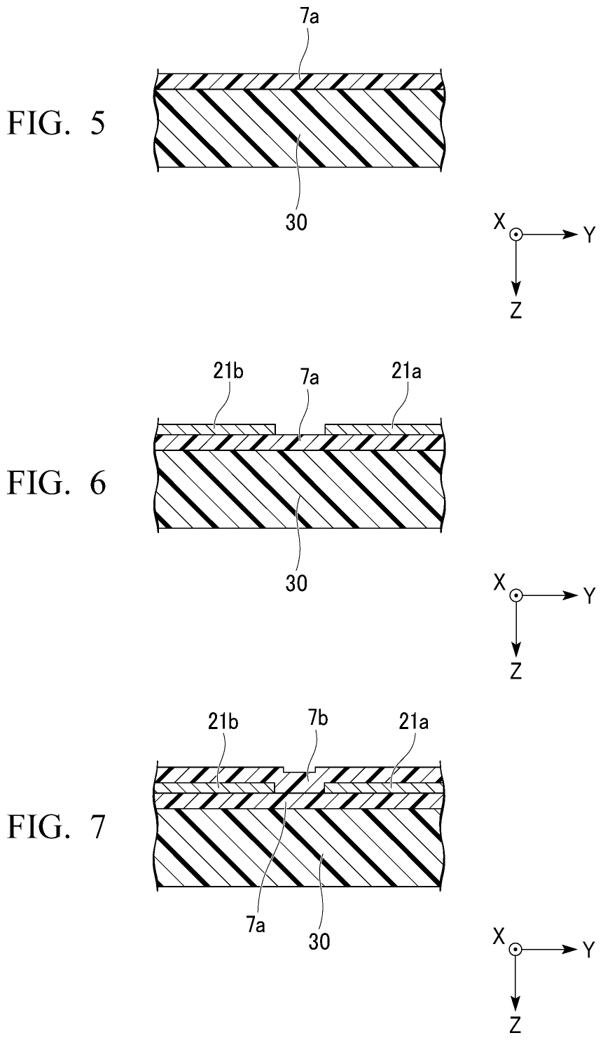

Then, for example, a conductive film formed of titanium (Ti) is formed on the whole surface of the first insulating film 7a illustrated in FIG. 5. Thereafter, the conductive film is patterned using photolithography technology. Accordingly, wiring layers 21a and 21b having a predetermined patterned shape are formed as illustrated in FIG. 6.

Then, as illustrated in FIG. 7, the second insulating film 7b formed of aluminum oxide (Al₂O₃) is formed on the whole surface of the wiring layers 21a and 21b.

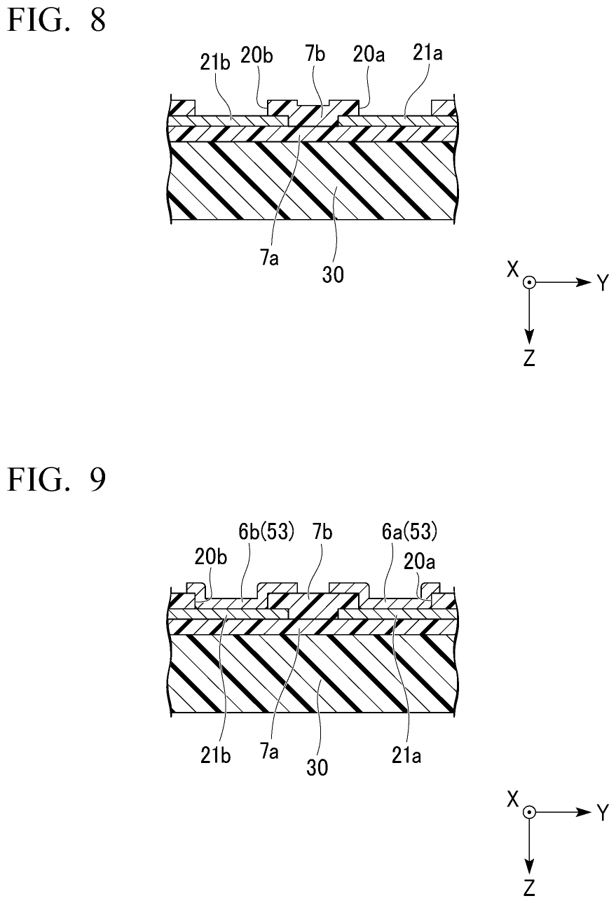

Then, the second insulating film 7b is patterned using photolithography technology. Accordingly, as illustrated in FIG. 8, the openings 20a and 20b penetrating the second insulating film 7b are formed on the wiring layers 21a and 21b.

Then, for example, a conductive film 53 formed of platinum (Pt) is formed on the whole surface of the second insulating film 7b including the openings 20a and 20b, and the conductive film 53 is embedded in the openings 20a and 20b. Thereafter, the conductive film 53 is patterned using photolithography technology. Accordingly, the first surface-side electrode 6 including the first electrode 6a and the second electrode 6b is formed as illustrated in FIG. 9.

In this embodiment, when the first surface-side electrode 6 is formed of platinum (Pt), the thickness of the first surface-side electrode 6 may range from 20 nm to 60 nm. When the thickness of the first surface-side electrode 6 formed of platinum (Pt) is equal to or greater than 20 nm, the first surface-side electrode 6 effectively serves as an oxygen diffusion suppressing layer for suppressing diffusion of oxygen from the second insulating film 7b to the thermistor film 5. The thickness of the first surface-side electrode 6 formed of platinum (Pt) may be equal to or less than 60 nm, since a process of patterning the conductive film 53 to form the first surface-side electrode 6 is facilitated.

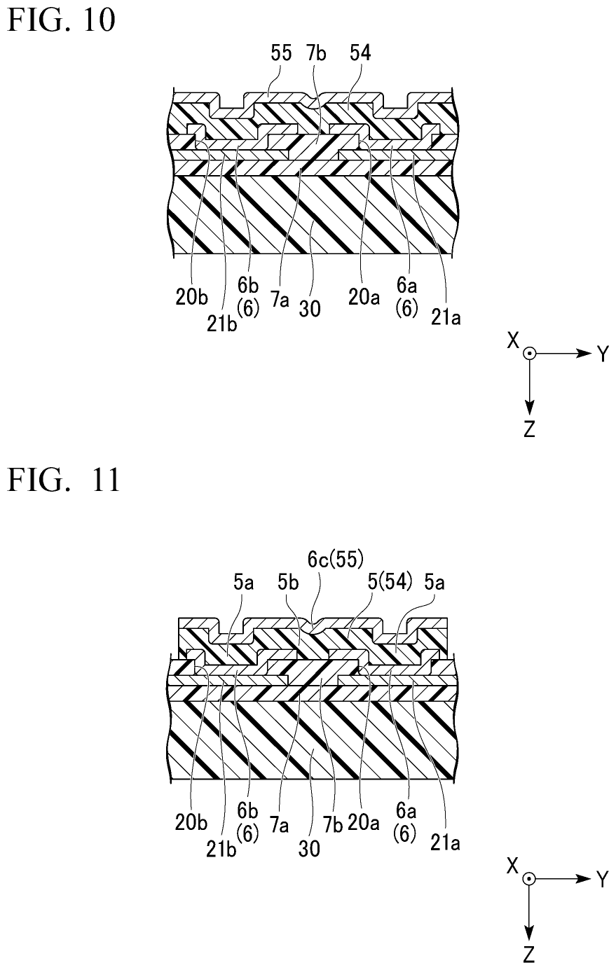

Then, as illustrated in FIG. 10, for example, a thermistor material film 54 formed of an oxide having a spinel crystal structure and a conductive film 55 formed of platinum (Pt) are sequentially formed on the whole surface of the second insulating film 7b in which the first surface-side electrode 6 is provided.

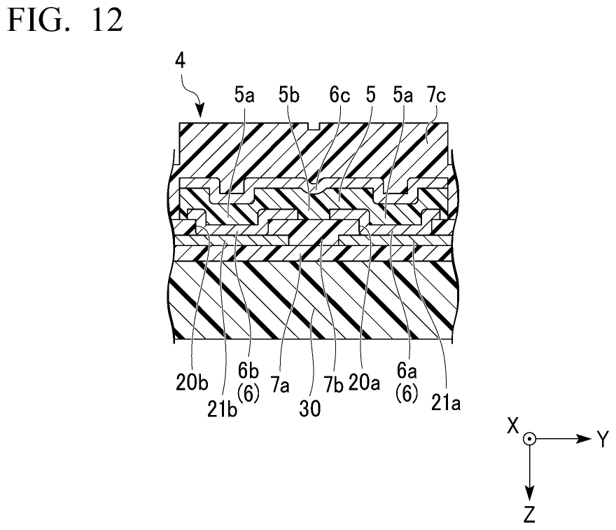

Then, the second surface-side electrode 6c and the thermistor film 5 patterned in the same shape are formed as illustrated in FIG. 11 by patterning the thermistor material film 54 and the conductive film 55 using photolithography technology.

In this embodiment, when the second surface-side electrode 6c is formed of platinum (Pt), the thickness of the second surface-side electrode 6c may range from 20 nm to 60 nm. When the thickness of the second surface-side electrode 6c formed of platinum (Pt) is equal to or greater than 20 nm, the second surface-side electrode 6c effectively serves as an oxygen diffusion suppressing layer for suppressing diffusion of oxygen from the heat treatment atmosphere (for example, the atmospheric air) to the thermistor film 5 at the time of heat treatment. The thickness of the second surface-side electrode 6c formed of platinum (Pt) may be equal to or less than 60 nm, since a process of patterning the conductive film 55 to form the second surface-side electrode 6c is facilitated.

Then, in this embodiment, heat treatment (annealing) is performed on the thermistor element in which layers up to the second surface-side electrode 6c are formed and of which manufacturing is being performed in the atmospheric air at 250° C. or higher. Accordingly, oxygen diffuses from the second insulating film 7b to the thermistor film 5 disposed in contact with the second insulating film 7b. At this time, diffusion of oxygen from the second insulating film 7b to the thermistor film 5 disposed in contact with the first surface-side electrode 6 (the first electrode 6a and the second electrode 6b) is suppressed by the first electrode 6a and the second electrode 6b. Diffusion of oxygen from the atmospheric air to the thermistor film 5 disposed in contact with the second surface-side electrode 6c is suppressed by the second surface-side electrode 6c. As a result, the thermistor film 5 in which the oxygen concentration in the second region 5b is higher than the oxygen concentration in the first region 5a is obtained.

The heat treatment temperature in the heat treatment is, for example, equal to or higher than 250° C. and may range from 250° C. to 325° C., for example, when the material of the second insulating film 7b is aluminum oxide (Al₂O₃). Since the heat treatment temperature is equal to or higher than 250° C., oxygen can be diffused from the second insulating film 7b to the thermistor film 5 disposed in contact with the second insulating film 7b. The heat treatment temperature may be equal to or lower than 325° C., since interlayer peeling due to a decrease in film thickness of the organic material layer 30 is less likely to occur.

For example, the heat treatment time in the heat treatment is set to a range of from 0.5 hours to 5 hours and may be set to a range of from 1 hour to 3 hours. The heat treatment time in the heat treatment can be appropriately determined according to the materials of the constituent members of the thermistor element 4, the material of the second insulating film 7b, and the material and the thickness of the thermistor film 5.

In this embodiment, since the atmosphere of the heat treatment is the atmospheric air, it is possible to suppress diffusion of oxygen from the atmospheric air to the thermistor film 5 using the second surface-side electrode 6c. On the other hand, for example, when the heat treatment is performed in the atmosphere of oxygen, an effect of preventing diffusion of oxygen from the atmosphere of oxygen to the thermistor film 5 using the second surface-side electrode 6c is not satisfactorily obtained, and there is a likelihood that the oxygen concentration of the thermistor film 5 as a whole increases.

Then, as illustrated in FIG. 12, for example, an insulating film formed of silicon dioxide (SiO₂) is formed on the whole surface of the second surface-side electrode 6c to form the third insulating film 7c covering the top surface of the second surface-side electrode 6c and the side surfaces of the second surface-side electrode 6c and the thermistor film 5. Thereafter, the thermistor element 4 and the arm parts 12a and 12b are formed in a predetermined shape as illustrated in FIG. 4 by performing patterning thereon.

Thereafter, a space G is formed by removing the organic material layer 30 through ashing. Through these processes, the thermistor element 4 is obtained.

A second substrate 3 including the aforementioned constituent members is manufactured using known methods.

Then, the second substrate 3 is disposed on one surface (a surface on the thermistor element 4 side) of the first substrate 2 including the thermistor element 4. Thereafter, the first substrate 2 and the second substrate 3 are electrically connected using the aforementioned members using a known method, and the surroundings of the opposite surfaces of the first substrate 2 and the second substrate 3 are sealed with a sealing member (not illustrated) to form a closed internal space K (see FIG. 2) therebetween.

Through these processes, the electromagnetic wave sensor 1 according to this embodiment is obtained.

The thermistor element 4 according to this embodiment includes a thermistor film 5 which is formed of an oxide having a spinel crystal structure and in which the oxygen concentration of the second region 5b located between the first electrode 6a and the second electrode 6b in a plan view is higher than the oxygen concentration of the first region 5a consisting of a region that overlaps the first electrode 6a and the second surface-side electrode 6c in a plan view and a region that overlaps the second electrode 6b and the second surface-side electrode 6c in a plan view. Accordingly, in the thermistor element 4 according to this embodiment, a current flows less easily in the in-plane direction in the second surface-side electrode 6c of the thermistor film 5.

Accordingly, in the electromagnetic wave sensor 1 including the thermistor element 4 according to this embodiment, a decrease in measurement accuracy due to a current component flowing in the in-plane direction in the thermistor film 5 of the thermistor element 4 is curbed, and the measurement accuracy is enhanced.

While an embodiment of the present disclosure has been described above in detail with reference to the drawings, the configurations in the embodiment, combinations thereof, and the like are merely examples, and the embodiment can be subjected to addition, omission, replacement, and other modification of an element without departing from the gist of the present disclosure.

For example, the thermistor element according to the present disclosure is not limited to application to an infrared image sensor in which the thermistor elements 4 are arranged in an array. The thermistor element according to the present disclosure may be applied to an electromagnetic wave sensor including only a single thermistor element 4 or may be applied to an electromagnetic wave sensor in which the thermistor elements 4 are arranged linearly.

The thermistor element according to the present disclosure may also be used as a temperature sensor that measures the temperature.

In the aforementioned embodiment, an example in which the oxygen concentration of the second region 5b is set to be higher than the oxygen concentration of the first region 5a of the thermistor film 5 formed of an oxide having a spinel crystal structure by performing heat treatment (annealing) at 250° C. or higher in the atmospheric air on a thermistor element in which constituent layers up to the second surface-side electrode 6c are provided and of which manufacturing is being performed has been described, but the method of manufacturing the thermistor element according to the present disclosure is not limited to the aforementioned method as long as the thermistor film 5 formed of an oxide having a spinel crystal structure in which the oxygen concentration of the second region 5b is higher than that of the first region 5a can be formed.

The planar shapes of the thermistor film 5, the first electrode 6a, the second surface-side electrode 6c, and the second electrode 6b included in the thermistor element 4 can be appropriately modified.

In the thermistor element 4 according to the embodiment, the shape and arrangement and the number of the openings 20a and 20b are not limited to the aforementioned configuration, but can be appropriately modified.

### EXAMPLES

### Example 1

### [Method of Manufacturing Electromagnetic Wave Sensor]

A thermistor element 4 illustrated in FIG. 12 was manufactured using the following manufacturing method.

The constituent members illustrated in FIG. 4 such as the first insulator layer 8, the wiring part 9, and the leg parts 13a and 13b were formed on a first substrate 2 formed of a silicon substrate, and then an organic material layer 30 formed of a resist was provided on the surface thereof on the first insulator layer 8 side. Then, as illustrated in FIG. 5, a first insulating film 7a with a thickness of 200 nm formed of aluminum oxide (Al₂O₃) was formed on the whole surface of the organic material layer 30 using a sputtering method.

Then, a conductive film with a thickness of 60 nm formed of titanium (Ti) was formed on the whole surface of the first insulating film 7a illustrated in FIG. 5 using a sputtering method. Thereafter, the conductive film was patterned using photolithography technology. Accordingly, wiring layers 21a and 21b having a predetermined pattern shape were formed as illustrated in FIG. 6.

Then, as illustrated in FIG. 7, a second insulating film 7b with a thickness of 70 nm formed of aluminum oxide (Al₂O₃) was formed on the whole surface of the wiring layers 21a and 21b using a sputtering method.

Then, the second insulating film 7b was patterned using photolithography technology. Accordingly, as illustrated in FIG. 8, openings 20a and 20b with a circular shape with a diameter of 1.2 μm penetrating the second insulating film 7b were formed on the wiring layers 21a and 21b.

Then, a conductive film 53 with a thickness of 30 nm formed of platinum (Pt) was formed on the whole surface of the second insulating film 7b including the openings 20a and 20b using a sputtering method, and the conductive film 53 was embedded in the openings 20a and 20b. Thereafter, the conductive film 53 was patterned using photolithography technology. Accordingly, as illustrated in FIG. 9, a first surface-side electrode 6 including the first electrode 6a and the second electrode 6b was formed.

Then, as illustrated in FIG. 10, a thermistor material film 54 with a thickness of 100 nm formed of an oxide having a spinel crystal structure and a conductive film 55 with a thickness of 20 nm formed of platinum (Pt) were sequentially formed on the whole surface of the second insulating film 7b in which the first surface-side electrode 6 was formed using a sputtering method.

An oxide having a spinel crystal structure (Co:Mn:Ni=43.7 at %:42.3 at %:14.0 at %) including Co and Mn as base metal elements and Ni as an additive element was used as the material of the thermistor material film 54.

Then, as illustrated in FIG. 11, a second surface-side electrode 6c and a thermistor film 5 which were patterned in the same shape were formed by patterning the thermistor material film 54 and the conductive film 55 using photolithography technology.

Then, heat treatment (annealing) was performed on the thermistor element in which layers up to the second surface-side electrode 6c were formed and of which manufacturing is being performed in the atmospheric air at 250° C. for 1 hour. Then, as illustrated in FIG. 12, a third insulating film 7c formed of aluminum oxide (Al₂O₃) was formed on the whole surface of the second surface-side electrode 6c using a sputtering method. Accordingly, the third insulating film 7c covering the top surface of the second surface-side electrode 6c and the side surfaces of the second surface-side electrode 6c and the thermistor film 5 was formed.

Thereafter, the organic material layer 30 was removed by ashing.

Through these processes, a thermistor element 4 according to Example 1 was obtained.

An oxygen concentration in the thickness direction in the thermistor film 5 of the obtained thermistor element 4 was measured using the following method.

### <<Measurement of Oxygen Concentration>>

A test sample was manufactured by film-processing the thermistor element 4 using a dual beam FIB (focus ion beam) processing and observation device (product name: Helios450F1; manufactured by Thermo Fisher Inc.). The test sample was manufactured such that a cross-section of the first region 5a consisting of a region that overlaps the first electrode 6a and the second surface-side electrode 6c in a plan view and a region that overlaps the second electrode 6b and the second surface-side electrode 6c in a plan view and a cross-section of the second region 5b located between the first electrode 6a and the second electrode 6b in a plan view in the thermistor film 5 can be observed.

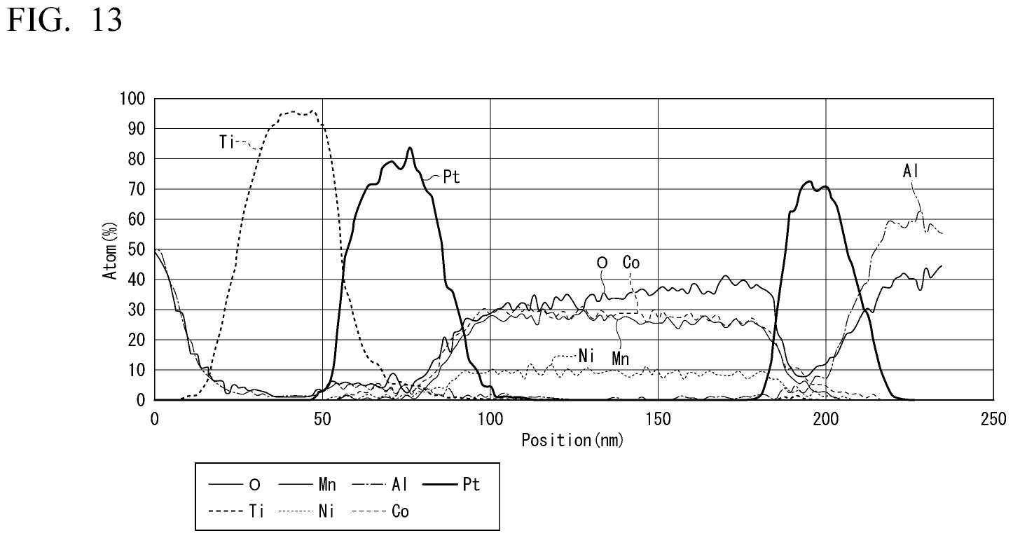

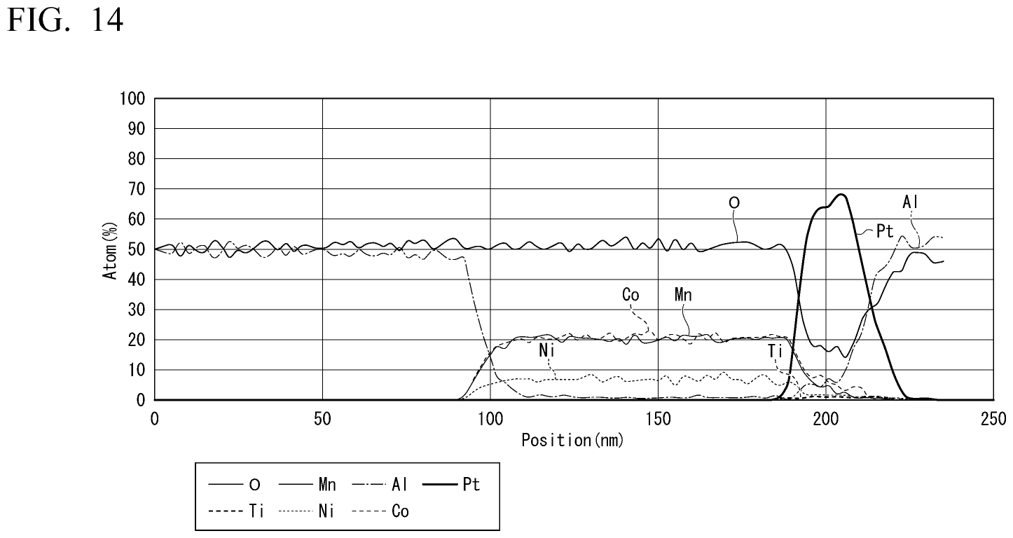

On the obtained test sample, energy distributed X-ray analysis (EDS) (product name: NSS (NORAN SYSTEM SEVEN); manufactured by Thermo Fisher Inc.) was performed while scanning the test sample from the first surface-side electrode 6 side to the second surface-side electrode 6c side using a scanning transmission electron microscope (STEM) (product name: ARM200F; manufactured by JEOL LTD.). Accordingly, element concentrations of oxygen (O), titanium (Ti), manganese (Mn), nickel (Ni), aluminum (Al), cobalt (Co), and platinum (Pt) in the thickness direction in the cross-section of the first region 5a and the cross-section of the second region 5b were measured. Results thereof are illustrated in FIGS. 13 and 14.

FIG. 13 is a graph illustrating a relationship between a position in the thickness direction of the cross-section including the first region 5a of the thermistor element 4 according to Example 1 and element concentrations. FIG. 14 is a graph illustrating a relationship between a position in the thickness direction of the cross-section including the second region 5b of the thermistor element 4 according to Example 1 and element concentrations. In FIGS. 13 and 14, the horizontal axis represents a position (nm) in the thickness between the first insulating film 7a and the third insulating film 7c when an arbitrary position in the first insulating film 7a is set to 0. The vertical axis in FIGS. 13 and 14 represents an element concentration (at %).

The peak of platinum (Pt) in FIGS. 13 and 14 indicates a position in the thickness direction of the first surface-side electrode 6 and the second surface-side electrode 6c in the test sample. The peak of titanium (Ti) indicates a position in the thickness direction of the wiring layers 21a and 21b in the test sample. The peaks of manganese (Mn), nickel (Ni), and cobalt (Co) indicate positions in the thickness direction of the thermistor film 5 in the test sample. The peak of aluminum (Al) indicates a position in the thickness direction of the first insulating film 7a, the second insulating film 7b, and the third insulating film 7c in the test sample.

The peak of oxygen (O) in the region in which manganese (Mn), nickel (Ni), and cobalt (Co) are detected in FIG. 13 indicates an oxygen concentration in the thermistor film 5 in the first region 5a.

The peak of oxygen (O) in the region in which manganese (Mn), nickel (Ni), and cobalt (Co) are detected in FIG. 14 indicates an oxygen concentration in the thermistor film 5 in the second region 5b.

As illustrated in FIG. 13, the oxygen concentration of the first region 5a in the thermistor film 5 ranges from 30 at % to 40 at %. As illustrated in FIG. 14, the oxygen concentration of the second region 5b in the thermistor film 5 was about 50 at % which is substantially constant in the thickness direction. Accordingly, it can be ascertained that the oxygen concentration of the second region 5b in the thermistor film 5 of the thermistor element 4 according to Example 1 is higher than the oxygen concentration of the first region 5a. As illustrated in FIGS. 13 and 14, when the thermistor film 5 is divided into three regions including a region close to the second surface-side electrode 6c, a region far from the second surface-side electrode 6c, and a region including a central part in the thickness direction, it can be ascertained in any of the three regions that the oxygen concentration of the second region 5b is higher than the oxygen concentration of the first region 5a.

### Test Example 1

An insulating film with a thickness of 200 nm formed of aluminum oxide (Al₂O₃) was formed on the whole surface of a silicon substrate, a thermistor material film with a thickness of 100 nm formed of an oxide having a spinel crystal structure was formed on the whole surface thereof, and thus a stacked sample according to Test Example 1 was obtained.

An oxide having a spinel crystal structure (Co:Mn:Ni=43.7 at %:42.3 at %:14.0 at %) including Co and Mn as base metal elements and Ni as an additive element was used as the material of the thermistor material film.

### Test Example 2

Similarly to Test Example 1, a stacked sample according to Test Example 2 was obtained in the same ways except that an oxide having a spinel crystal structure (Mn:Ni:Fe:Cu:Zr=35.1 at %:32.8 at %:24.1 at %:4.9 at %:3.1 at %) including Mn and Ni as base metal elements and Fe, Cu, and Zr as additive elements was used as the material of the thermistor material film.

In the thermistor material films of the stacked samples according to Test Example 1 and Test Example 2, a current was made to flow in the in-plane direction, and resistivity was measured using a four-probe sheet resistance measuring instrument (product name: Prometrix RS75; manufactured by KLA-Tencor Corporation). Results thereof are shown in Table 1.

Test samples were manufactured by film-processing the stacked samples according to Test Example 1 and Test Example 2 using a dual beam FIB (focus ion beam) processing and observation device (product name: Helios450F1; manufactured by Thermo Fisher Inc.).

On the obtained test samples, energy distributed X-ray analysis (EDS) (product name: NSS (NORAN SYSTEM SEVEN); manufactured by Thermo Fisher Inc.) was performed while scanning the test sample from the insulating film side of the thermistor material film to the surface side thereof using a scanning transmission electron microscope (STEM) (product name: ARM200F; manufactured by JEOL LTD.). Accordingly, the oxygen (O) concentration in the thickness direction in the cross-sections of the thermistor material films of the stacked samples according to Test Example 1 and Test Example 2 were measured.

Thereafter, an arithmetic means was calculated and used as an average oxygen concentration of the thermistor material film using the measurement results of the oxygen (O) concentration at the measuring points in a region including a central part when the thermistor film 5 was divided into three regions including a region close to the insulating film, a region far from the insulating film (a region close to the surface), and a region including a central part in the thickness direction. An interval in the thickness direction between the measuring points was 2.4 nm. Results thereof are shown in Table 1.

Heat treatment (annealing) in the atmospheric air at 250° C. for 1 hour was performed on the stacked samples according to Test Example 1 and Test Example 2. Thereafter, in the same way as before heat treatment was performed, a current was made to flow in the in-plane direction in the thermistor material films of the stacked samples according to Test Example 1 and Test Example 2, and resistivity was measured. Results thereof are shown in Table 1.

Test samples were taken from the stacked samples according to Test Example 1 and Test Example 2 after heat treatment (annealing) was performed in the same way as before heat treatment was performed, and the oxygen concentration in the thickness direction was measured and an average oxygen concentration of the thermistor material film was calculated in the same way as before heat treatment was performed. Results thereof are shown in Table 1.

TABLE 1

| | Test Example 1 | | Test Example 2 | |
|---|---|---|---|---|
| | | Oxygen | | Oxygen |
| | Resistivity | concentration | Resistivity | concentration |
| Annealing | Ω · cm | at % | Ω · cm | at % |
| After heat | 577 | 50 | 1565 | 52 |
| treatment | | | | |
| Before heat | 480 | 37 | 1300 | 41 |
| treatment | | | | |

As shown in Table 1, in any of Test Example 1 and Test Example 2, the oxygen concentration in the thermistor material film after heat treatment was performed was higher than that in the thermistor material film before heat treatment was performed. In any of Test Example 1 and Test Example 2, the resistivity in the thermistor material film in which the oxygen concentration after heat treatment was relatively high was higher than that in the thermistor material film in which the oxygen concentration before heat treatment is relatively low.

While embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the invention is not to be considered as being limited by the foregoing description, and is only limited by the scope of the appended claims.

What is claimed is:

1. A thermistor element comprising:
a thermistor film formed of an oxide having a spinel crystal structure;
a first surface-side electrode provided in contact with a first surface of the thermistor film; and
a second surface-side electrode provided in contact with a second surface of the thermistor film,
wherein the first surface-side electrode includes a first electrode and a second electrode that is disposed to be separated from the first electrode in a plan view, and at least a part of the first electrode and at least a part of the second electrode are disposed to overlap the second surface-side electrode in a plan view, and
in the thermistor film, an oxygen concentration of a second region located between the first electrode and the second electrode in a plan view is higher than an oxygen concentration of a first region consisting of a region that overlaps the first electrode and the second surface-side electrode in a plan view and a region that overlaps the second electrode and the second surface-side electrode in a plan view.

2. An electromagnetic wave sensor comprising at least one of the thermistor element according to claim 1.

3. The electromagnetic wave sensor according to claim 2,
wherein the at least one of the thermistor element includes a plurality of the thermistor elements, and
the thermistor elements are arranged in an array.
